(19) United States
(12) Patent Application Publication
(10) Pub. No.: US 2013/0113943 A1
(43) Pub. Date: May 9, 2013

(54) System and Method for Searching for Text and Displaying Found Text in Augmented Reality

(71) Applicants: Christopher R. Wormald, Waterloo (CA); Conrad Delbert Seaman, Guelph (CA); William Alexander Cheung, Waterloo (CA)

(72) Inventors: Christopher R. Wormald, Waterloo (CA); Conrad Delbert Seaman, Guelph (CA); William Alexander Cheung, Waterloo (CA)

(73) Assignee: RESEARCH IN MOTION LIMITED, Waterloo, ON (CA)

(21) Appl. No.: 13/634,754

(22) PCT Filed: Aug. 5, 2011
(86) PCT No.: PCT/CA2011/050478

§ 371 Date: Sep. 13, 2012

(51) Int. Cl. G06K 9/18

(52) U.S. Cl. 348/207.1; 382/182

(57) ABSTRACT

A system and a method for searching for text in one or more images are provided. The method, performed by a computing device, comprises receiving an input. The computing device generates a search parameter from the input, the search parameter comprising the text. Optical character recognition is applied to the one or more images to generate computer readable text. The search parameter is applied to search for the text in the computer readable text and, if the text is found, an action is performed.

### TECHNICAL FIELD

The following relates generally to searching for text data (e.g. letters, words, numbers, etc.).

### DESCRIPTION OF THE RELATED ART

Text can be printed or displayed in many media forms such as, for example, books, magazines, newspapers, advertisements, flyers, etc. It is known that text can be scanned using devices, such as scanners. However, scanners are typically large and bulky and cannot be easily transported. Therefore, it is usually inconvenient to scan text at any moment.

### BRIEF DESCRIPTION OF THE DRAWINGS

Embodiments will now be described by way of example only with reference to the appended drawings wherein:

FIG. 1a is a schematic diagram of a mobile device viewing a page of text, displaying an image of the text, and displaying an indication where text matching the search parameter is located.

FIG. 1b is a schematic diagram similar to FIG. 1a, in which the mobile device is viewing another page of text and displaying an indication where other text matching the search parameter is located.

FIG. 2 is a schematic diagram of a mobile device viewing a street environment, identifying road names, and using the road names to determine the mobile device's location and navigation directions.

FIG. 3 is a plan view of an example mobile device and a display screen.

FIG. 4 is a plan view of another example mobile device and a display screen therefor.

FIG. 5 is a plan view of the back face of the mobile device shown in FIG. 3, and a camera device therefor.

FIG. 6 is a block diagram of an example embodiment of a mobile device.

FIG. 7 is a screen shot of a home screen displayed by the mobile device.

FIG. 8 is a block diagram illustrating example ones of the other software applications and components shown in FIG. 6.

FIG. 9 is a block diagram of an example configuration of modules for performing augmented reality operations related to text.

FIG. 10 is a flow diagram of example computer executable instructions for searching for text and displaying an indication of where the sought text is found.

FIG. 11 is a flow diagram of example computer executable instructions for displaying the indication overlaid an image of the text.

FIG. 12 is a flow diagram of example computer executable instructions for recording page numbers and the number of instances of the sought text found on each page.

FIG. 13 is an example graphical user interface (GUI) for viewing the indexing of instances of sought text on each page, as well as for selecting an image containing the sought text.

FIG. 14 is a flow diagram of example computer executable instructions for identifying the page numbering.

FIG. 15 is another flow diagram of example computer executable instructions for identifying the page numbering.

FIG. 16 is a flow diagram of example computer executable instructions for searching for road names that are based on navigation directions.

FIG. 17 is a flow diagram of example computer executable instructions for searching for road names that are based on a first location of the mobile device.

FIG. 18 is a flow diagram of example computer executable instructions for searching for text in images.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is recognized that manually searching through a physical document for text can be difficult and time consuming. For example, a person may read through many pages in a document or a book to search for instances of specific words. If there are many pages (e.g. hundreds of pages), the person will need to read every page to determine where the instances of the specific words occur. The person may begin to rush through reading or reviewing the document or the book and may accidentally not notice instances of the specific words in the text. The person may be more likely not to notice instances of specific words when the content is unfamiliar or uninteresting.

In another example, a person is only looking for instances of specific words and does not care to read the other text which is considered extraneous, as only the immediately surrounding text of the specific words is considered relevant. Such a situation can make reading the document or the book tedious, and may, for example, cause the person to increase their rate of document review. This may, for example, directly or indirectly lead to increased instances where the person accidentally does not notice instances of the specific words.

A person reviewing a document and searching for specific words may also find the task to be a strain on the eyes, especially when the text is in small-sized font. It may be also difficult when reading text that is in a font style that is difficult to read. Such situations can cause a person's eyes to strain.

It is also recognized that when a person is travelling through streets, for example by foot or by car, the person may be distracted by many different types of signs (e.g. road signs, store front signs, billboards, advertisements, etc.). The person may not see or recognize the street signs that they are seeking.

A person may also not notice street signs if they are driving fast, or are focusing their visual attention to the traffic. It can be appreciated that driving while looking for specific streets signs can be difficult. The problem is further complicated when a person may be driving in an unfamiliar area, and thus does not know where to find the street signs. Moreover, street signs that are located far away can be difficult to read as the text may appear small or blurry to a person.

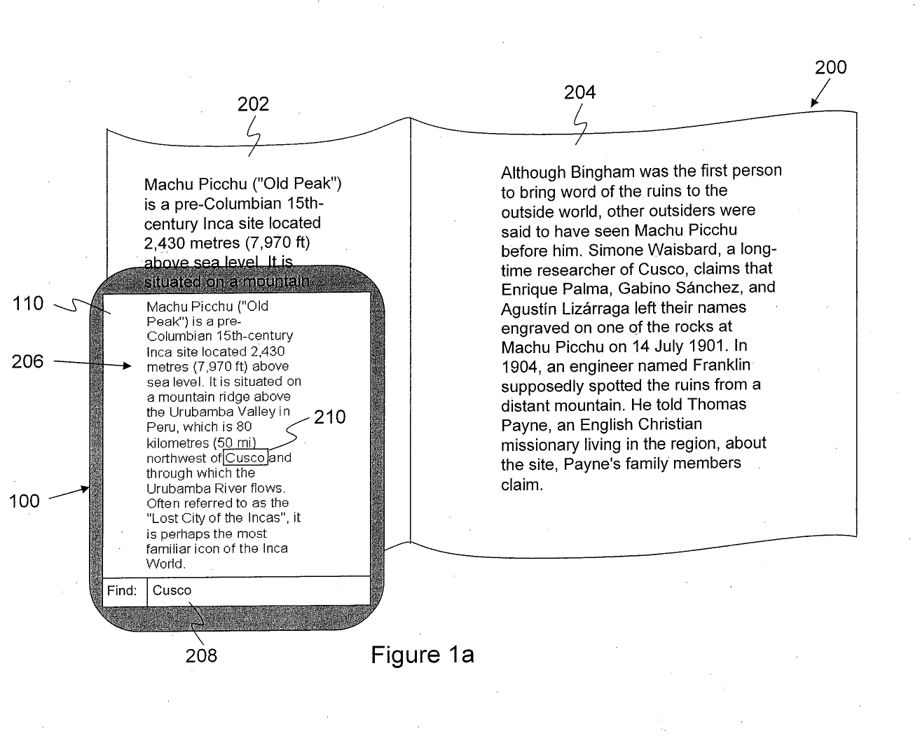

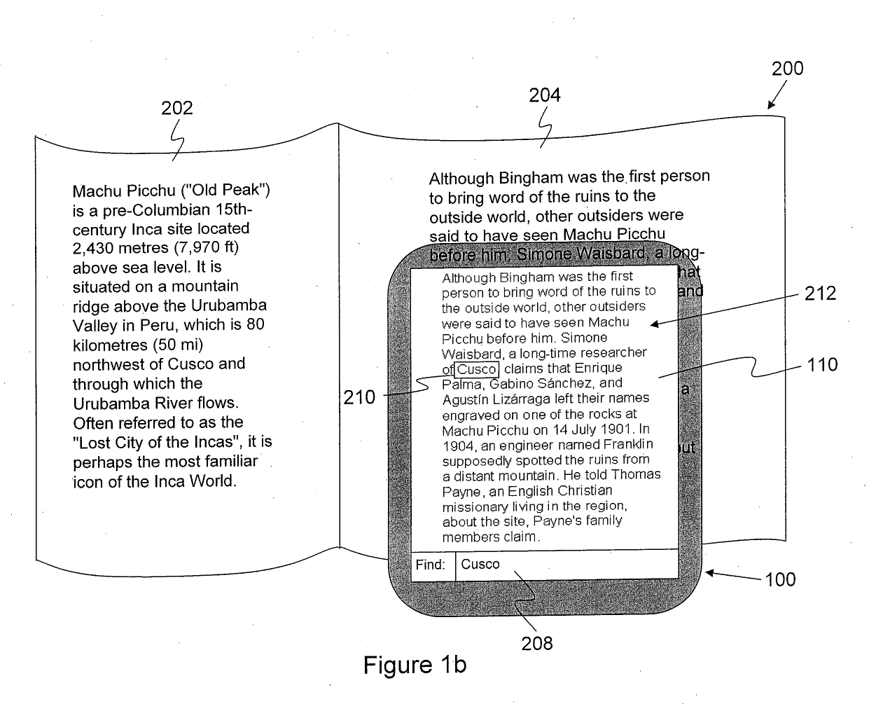

The present systems and methods described herein address such issues, among others. Turning to FIG. 1a, a book 200 is shown that is opened to pages 202, 204. A mobile device 100 equipped with a camera is showing images of the pages 202, 204 in real-time on the camera's display 110. In other words, as the mobile device 100 and the book 200 move relative to each other, the image displayed on the display 110 is automatically updated to show what is being currently captured by the camera.

In FIG. 1a, the camera is viewing page 202 and an image 206 of page 202 is shown on the display 110. In other words, an image of the text on page 202 is displayed. The display 110 also includes in its graphical user interface (GUI) a text field 208 in which a search parameter can be entered by a user though the GUI of display 110 and/or a keyboard or other input device (not shown in FIG. 1a) of mobile device 100. In other words, if a person is looking for specific instances of text (e.g. letter combinations, words, phrases, symbols, equations, numbers, etc.) in the book 200, the person can enter in the text to be searched into the text field 208. For example, a person may wish to search for the term “Cusco”, which is the search parameter shown in FIG. 1a, 208. The mobile device 100 uses optical character recognition (OCR) to derive computer readable text from the images of text, and, using the computer readable text, applies a text searching algorithm to find the instance of the search parameter. Once found, the mobile device 100 indicates where the search parameter is located. In the example, the location of the term “Cusco” is identified on the display 110 using a box 210 surrounding the image of the text “Cusco”. It can be appreciated that the box 210 may be overlaid on the image 206. This augments the reality which is being viewed by the person through the mobile device 100.

It can be appreciated that the imaged text is an image and its meaning is not readily understood by a computing device or mobile device 100. By contrast, the computer readable text includes character codes that are understood by a computing device or mobile device 100, and can be more easily modified. Non-limiting examples of applicable character encoding and decoding schemes include ASCII code and Unicode. The words from the computer readable text can therefore be identified and associated with various functions.

Turning to FIG. 1b, as the person moves the mobile device 100 from page 202 to 204, the display 110 is automatically updated with the current image being viewed or captured by the camera. It can be appreciated that the images being displayed on the display 110 may be updated almost instantaneously, in a real-time manner. In other words, when the camera is placed in front of page 204, the display 110 automatically shows the image 212 of page 204. As the search parameter “Cusco” is still being used, the mobile device 100 searches for the term “Cusco”. The box 210 is shown around the term “Cusco”, overlaid on the image 212 of the text on page 204. It can be appreciated that other methods for visually indicating the location of the word “Cusco” are applicable.

It can be appreciated that such a system and method may aid a person to quickly search for text in a document or a book, or other embodiments of text displayed in a hardcopy format. For example, a person can use the principles herein to search for specific words shown on another computer screen. The person moves the mobile device 100 to scan over pages of text, and when the search parameter is found, its position is highlighted on the display 110. This reduces the amount of effort for the person, since every word does not need to be read. If there are no indications that the search parameter is in the imaged text, then the person knows that the search parameter does not exist within the imaged text. The principles described herein may be more reliable compared to person manually searching for specific words.

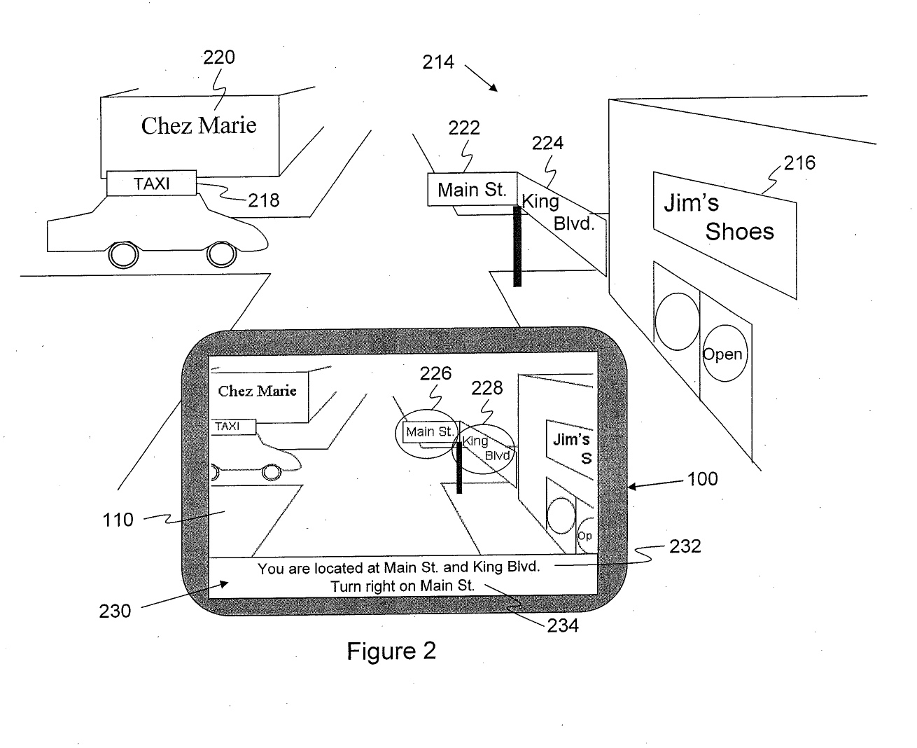

Turning to FIG. 2, a street environment 214 is shown. The street environment 214 includes buildings, a taxi, and some street signs. As described above, there can be many signs 216, 218, 220, 222, 224, which can be distracting to a person. For example, the person may be looking for specific road names to determine their location, or to determine an immediate set of navigation directions to reach a destination. If the person is driving, the person may not wish to look for road names, which can distract from the person's driving awareness.

The mobile device 100 is equipped with a camera that can be used to search for and identify specific road names that are in the street environment 214. In this example embodiment, the road names are the search parameters, which can be obtained from a set of directions (received at the mobile device 100 from e.g. a map server or other source providing directions), a current location (received at the mobile device 100 through e.g. a GPS receiver of the mobile device 100), or manual inputs from the person (received at the mobile device 100 through a GUI its display and/or keyboard or other input device). The mobile device 100 processes an image of the street environment by applying an OCR algorithm to the text in the image, thereby generating computer readable text. A search algorithm is then applied to the computer readable text to determine if the search parameters, in this example, road names, are present. If so, further actions may be performed.

In the example in FIG. 2, the mobile device 100 is searching for the road names “Main St.” and “King Blvd.” The text is shown on the street signs 222 and 224, respectively, and is recognized in the image captured of the street environment 214. Upon recognizing this, the mobile device 100 displays an indication of where the sought after text is located in the image. An example of such an indication can be displaying circles 226 and 228. In this way, the person can see where the road names “Main St.” and “King Blvd.” are located in the street environment 214. This augments the reality being viewed by the person. As the mobile device 100 or the text in the street environment 214 move (e.g. the person may orient the mobile device 100 to different direction, or the taxi sign 218 can move), the computer readable text is updated to correspond to the same currently imaged text.

Another action that is performed is displaying location and navigation information, shown in the interface 230 on the display 110. It is assumed that if the mobile device's camera can see the road names, then the mobile device 100 is currently located at the identified roads. Therefore, the interface 230 provides a message “You are located at Main St. and King Blvd.”.

Based on the current location of the mobile device 100, this can be integrated into a mapping application used to provide navigation directions. For example, the interface 230 may provide the direction “Turn right on Main St.”

In the example in FIG. 2, the mobile device 100 can be integrated into a car. For example, the mobile device, when integrated completely with a car, may not be handheld and thus may be an electronic device. An example of such an integrated device may include a camera device integrated with the front of a car, while the computing device performing the searching functions and processing of the images is integrated with the car's computer system.

Examples of applicable electronic devices include pagers, cellular phones, cellular smart-phones, wireless organizers, personal digital assistants, computers, laptops, tablets, handheld wireless communication devices, wirelessly enabled notebook computers, camera devices and the like. Such devices will hereinafter be commonly referred to as “mobile devices” for the sake of clarity. It will however be appreciated that the principles described herein are also suitable to an electronic device that is not mobile in of itself, e.g. a GPS or other computer system integrated in a transport vehicle such as a car.

In an example embodiment, the mobile device is a two-way communication electronic device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

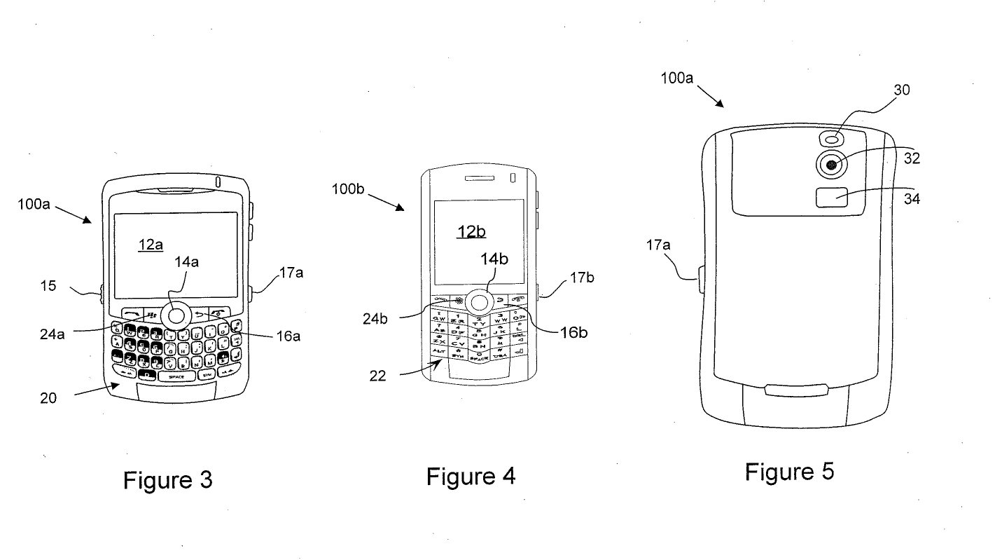

Referring to FIGS. 3 and 4, one example embodiment of a mobile device 100a is shown in FIG. 3, and another example embodiment of a mobile device 100b is shown in FIG. 4. It will be appreciated that the numeral “100” will hereinafter refer to any mobile device 100, including the example embodiments 100a and 100b, those example embodiments enumerated above or otherwise. It will also be appreciated that a similar numbering convention may be used for other general features common between all Figures such as a display 12, a cursor or view positioning device 14, a cancel or escape button 16, a camera button 17, and a menu or option button 24.

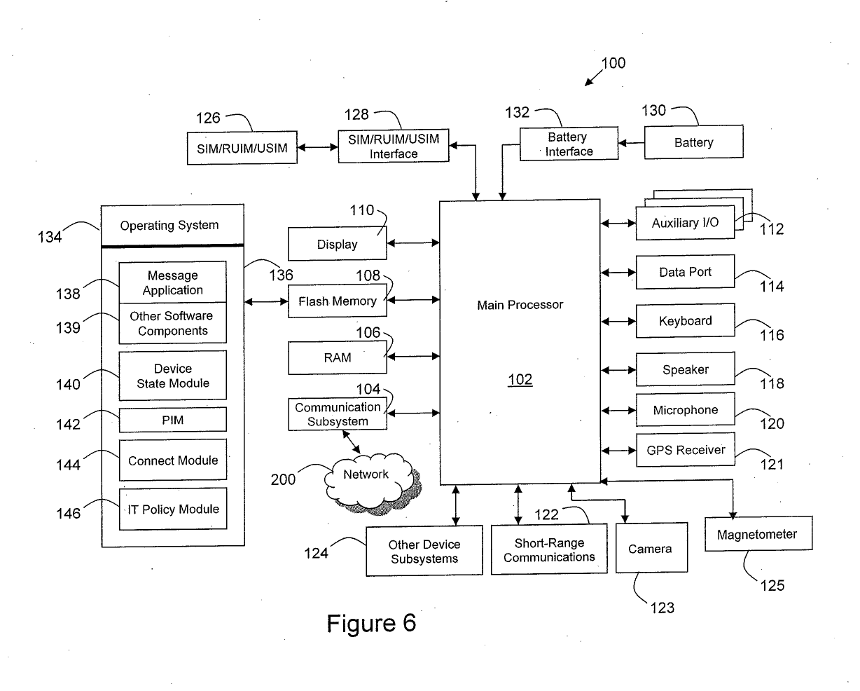

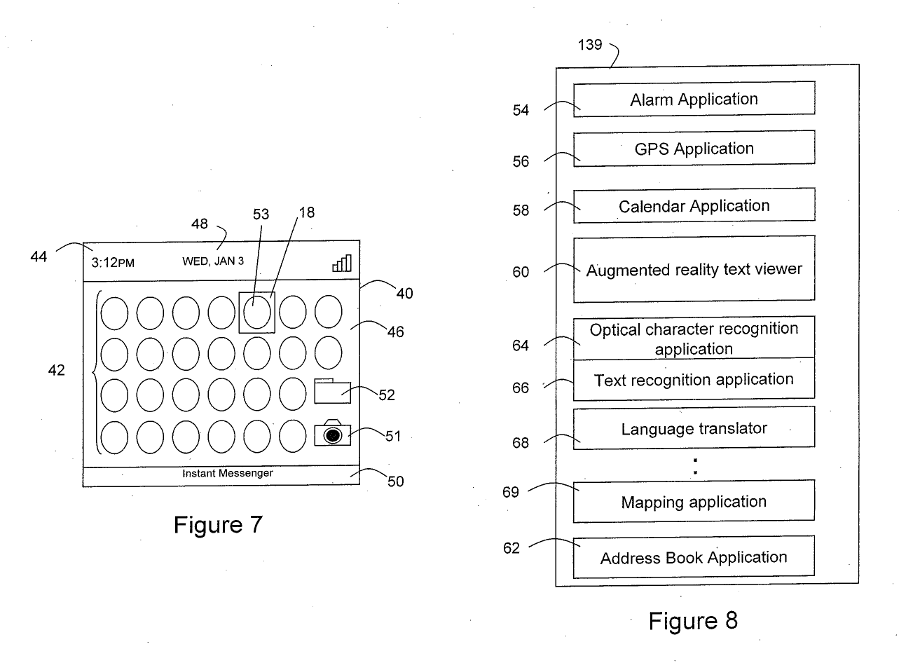

The mobile device 100a shown in FIG. 3 includes a display 12a and the positioning device 14 shown in this example embodiment is a trackball 14a. Positioning device 14 may serve as another input member and is both rotational to provide selection inputs to the main processor 102 (shown in FIG. 6) and can also be pressed in a direction generally toward housing to provide another selection input to the processor 102. Trackball 14a permits multi-directional positioning of the selection cursor 18 (shown in FIG. 7) such that the selection cursor 18 can be moved in an upward direction, in a downward direction and, if desired and/or permitted, in any diagonal direction. The trackball 14a is in this example situated on the front face of a housing for mobile device 100a as shown in FIG. 3 to enable a user to manoeuvre the trackball 14a while holding the mobile device 100a in one hand. The trackball 14a may serve as another input member (in addition to a directional or positioning member) to provide selection inputs to the processor 102 and can preferably be pressed in a direction towards the housing of the mobile device 100b to provide such a selection input.

The display 12 may include a selection cursor 18 (shown in FIG. 7) that depicts generally where the next input or selection will be received. The selection cursor 18 may include a box, alteration of an icon or any combination of features that enable the user to identify the currently chosen icon or item. The mobile device 100a in FIG. 3 also includes a programmable convenience button 15 to activate a selected application such as, for example, a calendar or calculator. Further, mobile device 100a includes an escape or cancel button 16a, a camera button 17a, a menu or option button 24a and a keyboard 20. The camera button 17 is able to activate photo and video capturing functions when pressed preferably in the direction towards the housing. The menu or option button 24 loads a menu or list of options on display 12a when pressed. In this example, the escape or cancel button 16a, the menu option button 24a, and keyboard 20 are disposed on the front face of the mobile device housing, while the convenience button 15 and camera button 17a are disposed at the side of the housing. This button placement enables a user to operate these buttons while holding the mobile device 100 in one hand. The keyboard 20 is, in this example embodiment, a standard QWERTY keyboard.

The mobile device 100b shown in FIG. 4 includes a display 12b and the positioning device 14 in this example embodiment is a trackball 14b. The mobile device 100b also includes a menu or option button 24b, a cancel or escape button 16b, and a camera button 17b. The mobile device 100b as illustrated in FIG. 4, includes a reduced QWERTY keyboard 22. In this example embodiment, the keyboard 22, positioning device 14b, escape button 16b and menu button 24b are disposed on a front face of a mobile device housing. The reduced QWERTY keyboard 22 includes a plurality of multi-functional keys and corresponding indicia including keys associated with alphabetic characters corresponding to a QWERTY array of letters A to Z and an overlaid numeric phone key arrangement.

It will be appreciated that for the mobile device 100, a wide range of one or more positioning or cursor/view positioning mechanisms such as a touch pad, a positioning wheel, a joystick button, a mouse, a touchscreen, a set of arrow keys, a tablet, an accelerometer (for sensing orientation and/or movements of the mobile device 100 etc.), or other whether presently known or unknown may be employed. Similarly, any variation of keyboard 20, 22 may be used. It will also be appreciated that the mobile devices 100 shown in FIGS. 3 and 4 are for illustrative purposes only and various other mobile devices 100 are equally applicable to the following examples. For example, other mobile devices 100 may include the trackball 14b, escape button 16b and menu or option button 24 similar to that shown in FIG. 4 only with a full or standard keyboard of any type. Other buttons may also be disposed on the mobile device housing such as colour coded “Answer” and “Ignore” buttons to be used in telephonic communications. In another example, the display 12 may itself be touch sensitive thus itself providing an input mechanism in addition to display capabilities.

Referring to FIG. 5, in the rear portion of mobile device 100a, for example, there is a light source 30 which may be used to illuminate an object for taking capturing a video image or photo. Also situated on the mobile device's rear face is a camera lens 32 and a reflective surface 34. The camera lens 32 allows the light that represents an image to enter into the camera device. The reflective surface 34 displays an image that is representative of the camera device's view and assists, for example, a user to take a self-portrait photo. The camera device may be activated by pressing a camera button 17, such as the camera button 17a shown in FIG. 3.

To aid the reader in understanding the structure of the mobile device 100, reference will now be made to FIGS. 6 through 8.

Referring first to FIG. 6, shown therein is a block diagram of an example embodiment of a mobile device 100. The mobile device 100 includes a number of components such as a main processor 102 that controls the overall operation of the mobile device 100. Communication functions, including data and voice communications, are performed through a communication subsystem 104. The communication subsystem 104 receives messages from and sends messages to a wireless network 200. In this example embodiment of the mobile device 100, the communication subsystem 104 is configured in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the example embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications.

The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, a GPS receiver 121, short-range communications 122, a camera 123, a magnetometer 125, and other device subsystems 124. The display 110 can be a touch-screen display able to receive inputs through a user's touch.

Some of the subsystems of the mobile device 100 perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list.

The mobile device 100 can send and receive communication signals over the wireless network 200 after required network registration or activation procedures have been completed. Network access is associated with a subscriber or user of the mobile device 100. To identify a subscriber, the mobile device 100 may use a subscriber module component or “smart card” 126, such as a Subscriber Identity Module (SIM), a Removable User Identity Module (RUIM) and a Universal Subscriber Identity Module (USIM). In the example shown, a SIM/RUIM/USIM 126 is to be inserted into a SIM/RUIM/USIM interface 128 in order to communicate with a network. Without the component 126, the mobile device 100 is not fully operational for communication with the wireless network 200. Once the SIM/RUIM/USIM 126 is inserted into the SIM/RUIM/USIM interface 128, it is coupled to the main processor 102.

The mobile device 100 is a battery-powered device and includes a battery interface 132 for receiving one or more rechargeable batteries 130. In at least some example embodiments, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells may provide the power to the mobile device 100.

The mobile device 100 also includes an operating system 134 and software components 136 to 146 which are described in more detail below. The operating system 134 and the software components 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 146, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, may be installed on the mobile device 100 during its manufacture. Software applications may include a message application 138, a device state module 140, a Personal Information Manager (PIM) 142, a connect module 144 and an IT policy module 146. A message application 138 can be any suitable software program that allows a user of the mobile device 100 to send and receive electronic messages, wherein messages are typically stored in the flash memory 108 of the mobile device 100. A device state module 140 provides persistence, i.e. the device state module 140 ensures that important device data is stored in persistent memory, such as the flash memory 108, so that the data is not lost when the mobile device 100 is turned off or loses power. A PIM 142 includes functionality for organizing and managing data items of interest to the user, such as, but not limited to, e-mail, contacts, calendar events, and voice mails, and may interact with the wireless network 200. A connect module 144 implements the communication protocols that are required for the mobile device 100 to communicate with the wireless infrastructure and any host system, such as an enterprise system, that the mobile device 100 is authorized to interface with. An IT policy module 146 receives IT policy data that encodes the IT policy, and may be responsible for organizing and securing rules such as the “Set Maximum Password Attempts” IT policy.

Other types of software applications or components 139 can also be installed on the mobile device 100. These software applications 139 can be pre-installed applications (i.e. other than message application 138) or third party applications, which are added after the manufacture of the mobile device 100. Examples of third party applications include games, calculators, utilities, etc.

The additional applications 139 can be loaded onto the mobile device 100 through at least one of the wireless network 200, the auxiliary I/O subsystem 112, the data port 114, the short-range communications subsystem 122, or any other suitable device subsystem 124.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the mobile device 100.

For voice communications, received signals are output to the speaker 118, and signals for transmission are generated by the microphone 120. Although voice or audio signal output is accomplished primarily through the speaker 118, the display 110 can also be used to provide additional information such as the identity of a calling party, duration of a voice call, or other voice call related information.

Turning now to FIG. 7, the mobile device 100 may display a home screen 40, which can be set as the active screen when the mobile device 100 is powered up and may constitute the main ribbon application. The home screen 40 generally includes a status region 44 and a theme background 46, which provides a graphical background for the display 12. The theme background 46 displays a series of icons 42 in a predefined arrangement on a graphical background. In some themes, the home screen 40 may limit the number icons 42 shown on the home screen 40 so as to not detract from the theme background 46, particularly where the background 46 is chosen for aesthetic reasons. The theme background 46 shown in FIG. 7 provides a grid of icons. It will be appreciated that preferably several themes are available for the user to select and that any applicable arrangement may be used. An example icon may be a camera icon 51 used to indicate an augmented reality camera-based application. One or more of the series of icons 42 is typically a folder 52 that itself is capable of organizing any number of applications therewithin.

The status region 44 in this example embodiment includes a date/time display 48. The theme background 46, in addition to a graphical background and the series of icons 42, also includes a status bar 50. The status bar 50 provides information to the user based on the location of the selection cursor 18, e.g. by displaying a name for the icon 53 that is currently highlighted.

An application, such as message application 138 (shown in FIG. 6) may be initiated (opened or viewed) from display 12 by highlighting a corresponding icon 53 using the positioning device 14 and providing a suitable user input to the mobile device 100. For example, message application 138 may be initiated by moving the positioning device 14 such that the icon 53 is highlighted by the selection box 18 as shown in FIG. 7, and providing a selection input, e.g. by pressing the trackball 14b.

FIG. 8 shows an example of the other software applications and components 139 (also shown in FIG. 6) that may be stored and used on the mobile device 100. Only examples are shown in FIG. 8 and such examples are not to be considered exhaustive. In this example, an alarm application 54 may be used to activate an alarm at a time and date determined by the user. There is also an address book 62 that manages and displays contact information. A GPS application 56 may be used to determine the location of a mobile device 100. A calendar application 58 that may be used to organize appointments. Another example application is an augmented reality text viewer application 60. This application 60 is able to augment an image by displaying another layer on top of the image, whereby the layer includes providing indications of where search parameters (e.g. text) are located in an image.

Other applications include an optical character recognition application 64, a text recognition application 66, and a language translator 68. The optical character recognition application 64 and the text recognition application 66 may be a combined application or different application. It can also be appreciated that other applications or modules described herein can also be combined or operate separately. The optical character recognition application 64 is able to translate images of handwritten text, printed text, typewritten text, etc. into computer readable text, or machine encoded text. Known methods and future methods of translating an image of text into computer readable text, generally referred to as OCR methods, can be used herein. The OCR application 64 is also able to perform intelligent character recognition (ICR) to also recognize handwritten text. The text recognition application 66 recognizes the combinations of computer readable characters that form words, phrases, sentences, paragraphs, addresses, phone numbers, dates, etc. In other words, the meanings of the combinations of letters can be understood. Known text recognition software is applicable to the principles described herein. A language translator 68 translates the computer readable text from a given language to another language (e.g. English to French, French to German, Chinese to English, Spanish to German, etc.). Known language translators can be used.

Other applications can also include a mapping application 69 which provides navigation directions and mapping information. It can be appreciated that the functions of various applications can interact with each other, or can be combined.

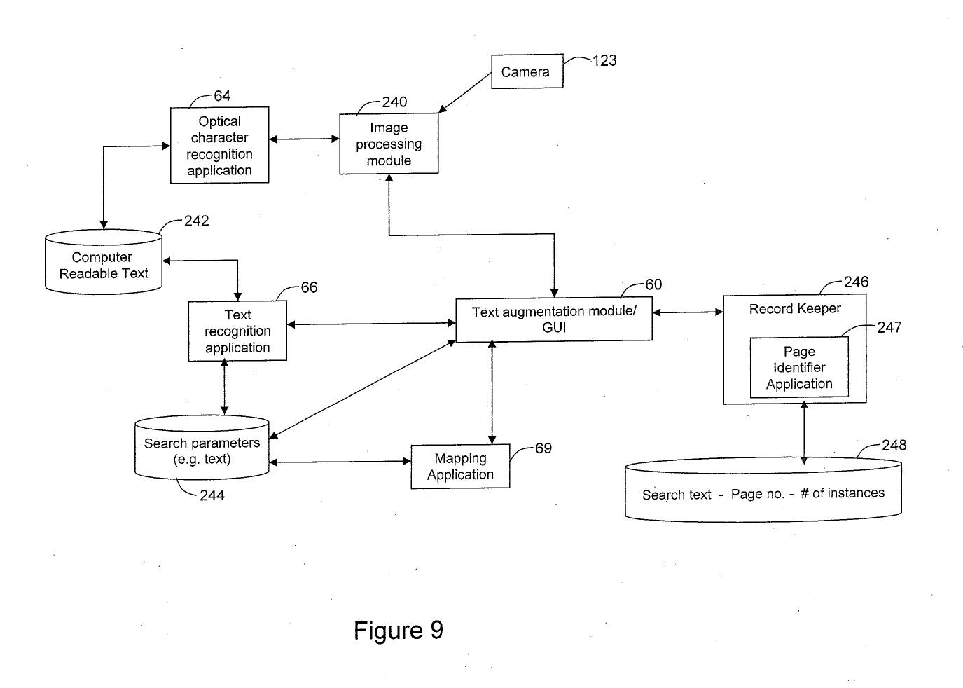

Turning to FIG. 9, an example configuration for augmenting reality related to text is provided. An input is received from the camera 123. In particular, the text augmentation module/GUI 60receives camera or video images (which may be processed by image processing module 240 and) which may contain text. Using the images, the text augmentation module/GUI 60 can display the image on the display screen 110. In an example embodiment, the images from the camera 123 can be streaming video images that are updated in a real-time manner.

Continuing with FIG. 9, the images received from the camera 123 may be processed using an image processing module 240. For example, the image processing module 240 may be used to adjust the brightness settings and contrast settings of the image to increase the definition of the imaged text. Alternatively, or additionally, the exposure settings of the camera 123 may be increased so that more light is absorbed by the camera (e.g. the charge-coupled device of the camera). The image, whether or processed or not, is also sent to the text augmentation module/GUI 60.

The image may also be processed using an OCR application 64, which derives computer readable text from an image of text. The computer readable text may be stored in database 242. A text recognition application 66 is used to search for specific text in the computer readable text. The specific text that is being sought after are search parameters stored in a database 244. The database 244 can receive search parameters through the text augmentation module/GUI 60, or from a mapping application 69. As discussed earlier, the search parameters can be text entered by a person, or, among other things, be text derived from navigation directions or location information.

If the text recognition application finds the search parameters, then this information is passed back to the text augmentation module/GUI 60. The text augmentation module/GUI 60 may display an indicator of where the sought after text is located in the image. This is shown for example, in FIG. 1a and FIG. 1b. If one or more of the search parameters are found, the information can also be passed to the mapping application 69 to generate location information or navigation directions, or both.

The identified instances of search parameters can also be saved in a database 248, which organizes or indexes the found instances of search parameters by page number. This is facilitated by the record keeper application 246, which can also include a page identifier application 247. The record keeper application 246 counts and stores the number of instances of a search parameter on a give page number. A copy of the imaged text may also be displayed in the database 248.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 100 or accessible or connectable thereto. Any application or module herein described may be implemented using computer readable/executable instructions or operations that may be stored or otherwise held by such computer readable media.

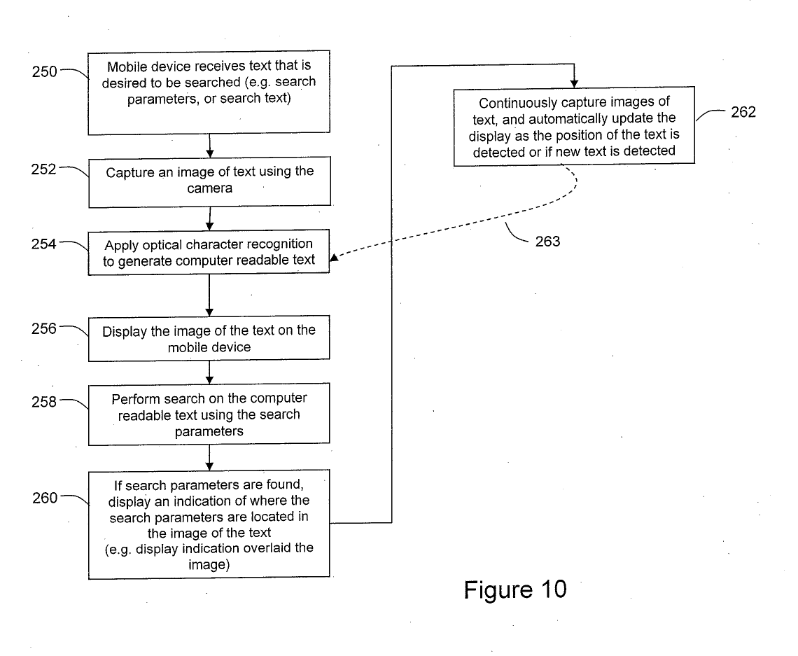

Turning to FIG. 10, example computer executable instructions are provided for searching for text in an image. At block 250, the mobile device 100 receives text. It can be appreciated that a person desires to search for the text, and thus, in an example embodiment, has inputted the text into the mobile device 100. This text can be referred herein as search parameters, search text, or sought text. The search parameters can, for example, be entered into the mobile device 100 through a text augmentation module/GUI 60, such as the text field 208 in FIG. 1a. At block 252, the mobile device 100 captures an image of text using the camera 123. The image may be static or part of a video stream of real time images. In another example embodiment, video data taken at another time, and optionally from a different camera device, can be searched using the search parameters according to the principles described herein. At block 254, an OCR algorithm is applied to generate computer readable text. At block 256, the image of the text is displayed on the mobile device's display 110. At block 258, the mobile device 100 performs a search on the computer readable text using the search parameters. If the search parameters are found, at block 260, the mobile device 100 displays an indication of where the search parameters are located in the image of the text. In an example embodiment, the indication can be a message stating where the search parameter can be found on the screen, or in which paragraph. In another example embodiment, the indication can be overlaid on the imaged text, directly pointing out the location of the search parameter.

At block 262, the mobile device 100 continues to capture images of text, and automatically updates the display 110 as the new position of the text is detected, or if new text is detected. For example, if a person moves the mobile device 100 downwards over a page of text, the position of the image of the text on the display 110 correspondingly moves upwards. Thus, if the search parameter is in the imaged text, the indication, such as a box 210, also moves upwards on the display 110. In another example, if a person moves the mobile device 100 to a different page that contains multiple instances of the search parameter, then the all the instances of the search parameters are shown, for example, by automatically displaying a box 210 around each of the instances of the search parameters.

In other words, in an example embodiment, the mobile device 100 continuously captures additional image and automatically updates the display of the indications when the position of the corresponding imaged text changes location. Similarly, the mobile device 100 continuously captures additional images of text and, if new text is detected, automatically updates the display 110 with other indications that are overlaid on the image of the search parameters.

In an example embodiment, the process of blocks 254 to 262 repeat in a real-time manner, or very quickly, in order to provide an augmented reality experience. The repetition or looping is indicated by the dotted line 263.

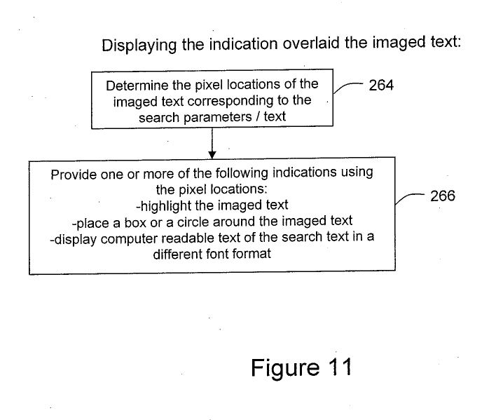

Turning to FIG. 11, an example embodiment is provided for displaying a location indication that overlays the imaged text. At block 264, the mobile device 100 determines the pixel locations of the imaged text corresponding to the search parameters. Then a graphical indication is displayed in relation to the pixel locations, for example, by: highlighting the imaged text, placing a box or a circle around the imaged text, and displaying computer readable text of the search parameter in a different font format (e.g. bold font) overlaid the corresponding imaged text (block 266). For example, returning the example in FIG. 1a, the computer readable text “Cusco” may be displayed in bold font or a different font and overlaid the image of the text “Cusco”. It can be appreciated that there may be various other ways of displaying an indication of where the sought text is located in the image.

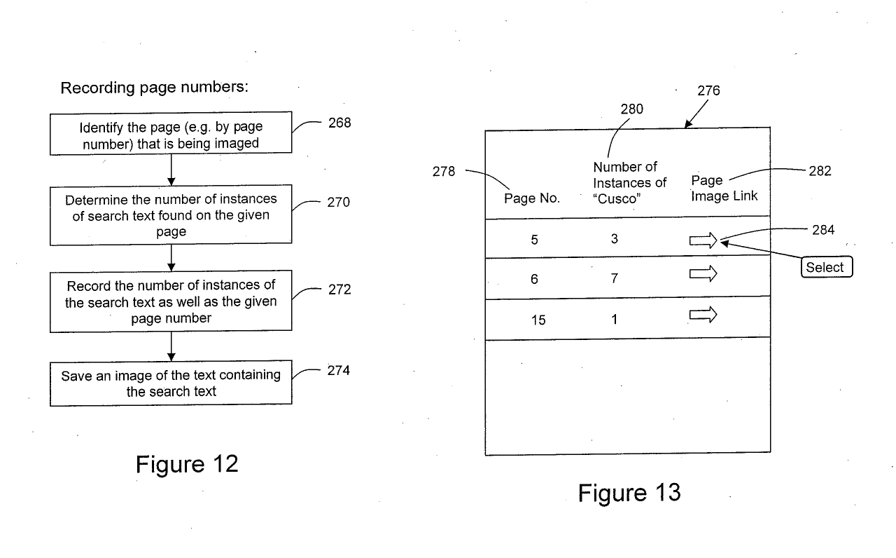

In FIG. 12, example computer executable instructions are provided for recording instances of search parameters. At block 268, the mobile device 100 identifies the page that is being imaged. The page can be identified by page number, for example. At block 270, the number of instances that the search text or search parameter appears in the imaged text is determined. A counting algorithm can be used to determine the number of instances.

At block 272, the number of instances of the search parameter, as well as the given page number, are recorded and stored in the database 248. An image of the text, containing the search parameter, is also saved (block 274).

This allows a person to easily identify which pages are relevant to the search parameter, as well to identify the number of instances of the search parameter. For example, a page with a higher number of instances may be more relevant to the person than a pages with fewer number of instances. The person can also conveniently retrieve the image of the text to read the context in which the search parameter was used.

An example GUI 276 for viewing the pages on which a search parameter appears is shown in FIG. 13. There are headings including the page number 278, the number of instances of the search parameter (e.g. “Cusco”), and a page image link 282. For example, the example GUI 276 shows that on page 5, there are three instances of the word “Cusco”. When the mobile device 100 receives a selection input on the button or link 284, an image of page 5 can then be displayed showing where the instances of “Cusco” are located.

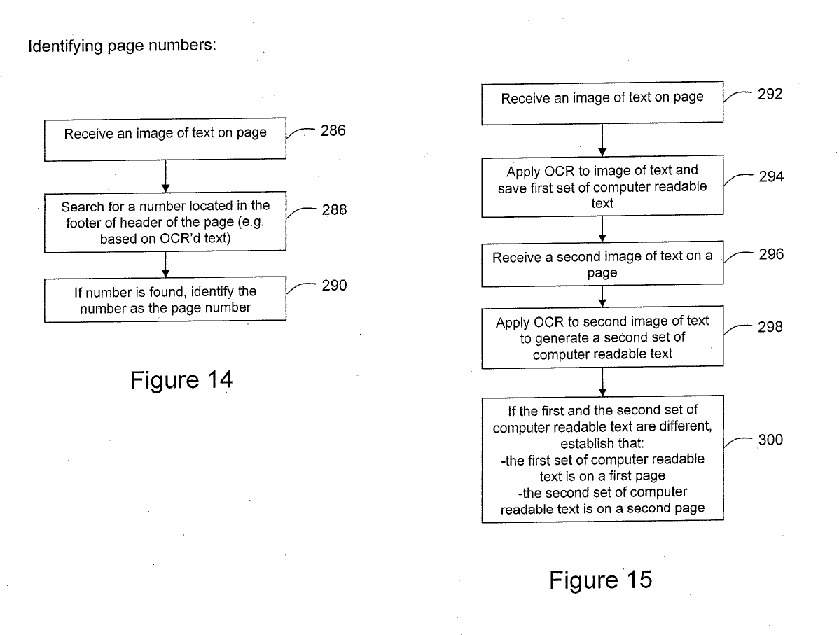

Turning to FIGS. 14 and 15, and further to block 268 (of FIG. 12), example computer executable instructions are provided for identifying page numbers. It can be appreciated that the page numbers can be manually identified or entered by the person. Alternatively, the page numbers can be automatically identified, as described below.

Referring to FIG. 14, in an example embodiment, the mobile device 100 receives the image of the text on the page (block 286). The mobile device 100 searches of a number located in the footer or header region of the page (block 288). The number can be identified using the OCR application 64. The footer or header region is searched since this is typically where the page numbers are located. If the number is found, then the identified page number is the page number (block 290). For example, if the number “14” is found on the footer of the page, then the page is identified as being “page 14”.

FIG. 15 provides an example embodiment which is used to detect that a page has turned. It is based on the assumption that the pages are turned from one page to the next page. At block 292, the mobile device 100 receives an image of text on a page. The mobile device 100 applies an OCR algorithm to the image of the text, and saves the first set of computer readable text (block 294). The mobile device 100 assumes that the first set of computer readable text is on a “first page” (e.g. not necessarily page 1). The mobile device 100 then receives a second image of text on a page (block 296). An OCR algorithm is applied to the second image to generate a second set of compute readable text (block 298). If the first set and the second set of computer readable text are different, then at block 300 the mobile device 100 establishes that the first of computer readable text is on a “first page”, and the second set of computer readable text is on a “second page” (e.g. not necessarily page 2, but a consecutive number after the first page). For example, if the first page is identified as page 14, then the second page is identified as page 15.

It can be appreciated that the principles described herein for searching for text in images can be applied to providing location information and navigation directions. This was described earlier, for example, with respect to FIG. 2.

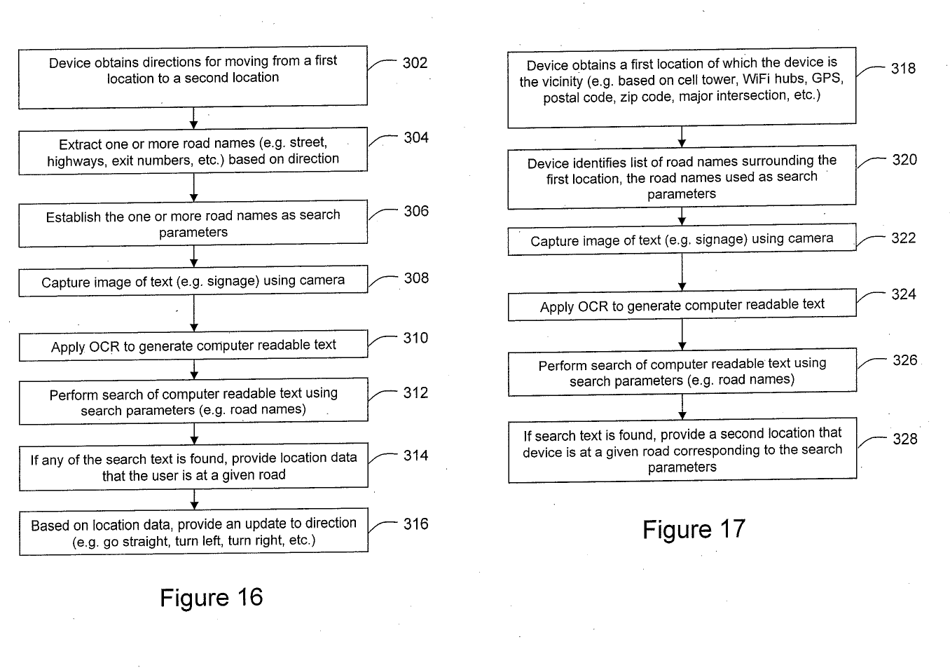

Turning to FIG. 16, example computer executable instructions are provided for searching for road names based on directions. At block 302, the mobile device 100 obtains directions for travelling from a first location to a second location. This, for example, includes a list or road names that are to be travelled along in certain directions and in a certain sequence. It can be appreciated that the input in this example embodiment are the directions. At block 304, one or more road names are extracted from the directions. It can be appreciated that non-limiting examples of road names include names of streets, highways and exit numbers. At block 306, the one or more road names are established as search parameters. If there are multiple road names in the directions, then these multiple road names are all search parameters. The mobile device 100 then obtains or captures images of text, for example from signage, using a camera (block 308). An OCR algorithm is applied to generate computer readable text from the images (block 310). A search of the computer readable text is then performed using the search parameters, in this example being the road names (block 312). If any of the road names are found (block 314), then location data is determined based on the identified road name. For example, referring back to FIG. 2, if the directions of block 302 include the road names “Main St.” and “King Blvd.”, and the text of such names are found, then it is known that the mobile device 100 is located at the intersection of Main St. and King Blvd. Therefore, the mobile device 100 knows where it is located along the route identified by the directions, and thus knows the next set of navigation directions to follow in the sequence of directions. At block 316, based on the location data, the mobile device 100 provides an update to the direction (e.g. go straight, turn left, turn right, etc.). For example, referring to FIG. 2, the direction 234 states “Turn right on Main St.”

The above approach can be used to supplement or replace the GPS functionality. An example scenario in which the approach may be useful is during travelling in a tunnel, and there is no GPS signal available. The above image recognition and mapping functionality can be used to direct a person to travel in the correct direction. Furthermore, by searching for only specific road names, as provided from the directions, other road names or other signs can be ignored. This reduces the processing burden on the mobile device 100.

In another example embodiment, turning to FIG. 17, example computer executable instructions are provided for determining a more precise location using the text searching capabilities. A first location is obtained, which may be an approximate location with some uncertainty. The first location is considered an input that is used to derive a list of road names which are used as search parameters. When the sought after road names have been found in the image or images, the road names that have been found are used to determine a more precise location.

In particular, at block 318, the mobile device 100 obtains a first location of which the device is in the vicinity. The first location can be determined by cell tower information, the location of wireless or Wi-Fi hubs, GPS, etc. The first location can also be determined by manually entered information, such as a postal code, zip code, major intersection, etc. Based on this input, which is considered an approximation of the region in which the mobile device 100 is located, the mobile device 100 identifies a set of road names surrounding the first location (block 320). The surrounding road names can be determined using the mapping application 69. These road names are used as search parameters.

Continuing with FIG. 17, at block 322, the mobile device 100 captures images of text (e.g. signage) using the camera 123. An OCR algorithm is applied to the image to generate computer readable text (block 324). At block 326, a search of the computer readable text is performed using the search parameters (e.g. the road names). If one or more of the road names is found (block 328), then it is assumed that the mobile device 100 is located at the one or more road names. The mobile device 100 then provides a second location indicating more precisely the device is located at a given road or given roads corresponding to the search parameters. This is shown for example in FIG. 2, in the statement 232 “You are located at Main St. and King Blvd.”

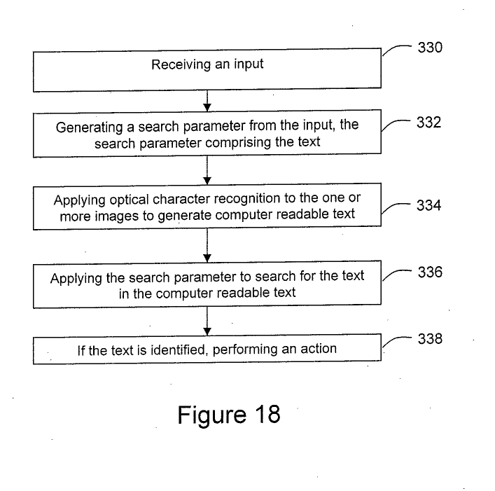

More generally, turning to FIG. 18, a system and a method for searching for text in one or more images are provided. The method, performed by a computing device, includes: receiving an input (block 330); generating a search parameter from the input, the search parameter including the text (block 332); applying optical character recognition to the one or more images to generate computer readable text (block 334); applying the search parameter to search for the text in the computer readable text (block 336); and if the text is found, performing an action (block 338).

In another aspect, the method further includes continuously capturing additional images in real-time, automatically applying the optical character recognition to the additional images to generate additional computer readable text, and, if the text is found again, performing the action again. In another aspect, the computing device is a mobile device including a camera, and the one or more images are provided by the camera. In another aspect, the input is text. In another aspect, the text is provided by a user. In another aspect, the action performed is highlighting the text that is found on a display. In another aspect, the one or more images are of one or more pages, and the computing device records the one or more pages on which the text that is found is located. In another aspect, the one or more pages are each identified by a page number, determined by applying optical character recognition to the page number. In another aspect, the one or more pages are each identified by a page number, the page number determined by counting the number of pages reviewed in a collection of pages. In another aspect, the method further includes recording the number of instances of the text that is found on each of the one or more pages. In another aspect, the input is a location. In another aspect, the search parameter(s) generated are one or more road names based on the location. In another aspect, the search parameter is generated from the set of directions to reach the location, the search parameter including the one or more road names. In another aspect, upon having found the text of at least one of the one or more road names, the action performed is providing an audio or a visual indication to move in a certain direction based on the set of direction. In another aspect, one or more road names are identified which are near the location, the search parameter including the one or more road names. In another aspect, upon having found the text of at least one of the one or more of the road names, the action performed is providing a second location including the road name that has been found.

A mobile device is also provided, including: a display; a camera configured to capture one or more images; and a processor connected to the display and the camera, and configured to receive an input, generate a search parameter from the input, the search parameter including the text, apply optical character recognition to the one or more images to generate computer readable text, apply the search parameter to search for the text in the computer readable text, and if the text is found, perform an action.

A system is also provided, including: a display; a camera configured to capture one or more images; and a processor connected to the display and the camera, and configured to receive an input, generate a search parameter from the input, the search parameter including the text, apply optical character recognition to the one or more images to generate computer readable text, apply the search parameter to search for the text in the computer readable text, and if the text is found, perform an action. In an example embodiment, such a system is integrated with a transport vehicle, such as a car.

The schematics and block diagrams used herein are just for example. Different configurations and names of components can be used. For instance, components and modules can be added, deleted, modified, or arranged with differing connections without departing from the spirit of the invention or inventions.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

It will be appreciated that the particular example embodiments shown in the figures and described above are for illustrative purposes only and many other variations can be used according to the principles described. Although the above has been described with reference to certain specific example embodiments, various modifications thereof will be apparent to those skilled in the art as outlined in the appended claims.

1. A method for searching for text in at least one image, the method performed by a computing device, the method comprising:
receiving an input;
generating a search parameter from the input, the search parameter comprising the text;
applying optical character recognition to the at least one image to generate computer readable text;
applying the search parameter to search for the text in the computer readable text; and
if the text is found, performing an action.

2. The method of claim 1 further comprising continuously capturing additional images in real-time, automatically applying the optical character recognition to the additional images to generate additional computer readable text, and, if the text is found again, performing the action again.

3. The method of claim 1 wherein the computing device is a mobile device comprising a camera, and the at least one image are provided by the camera.

4. The method of claim 1 wherein the input is text.

5. The method of claim 4 wherein the text is provided by a user.

6. The method of claim 4 wherein the action performed is highlighting the text that is found on a display.

7. The method of claim 4 wherein the at least one image are of one or more pages, and the computing device records the one or more pages on which the text that is found is located.

8. The method of claim 7 wherein the one or more pages are each identified by a page number, determined by applying optical character recognition to the page number.

9. The method of claim 7 wherein the one or more pages are each identified by a page number, the page number determined by counting the number of pages reviewed in a collection of pages.

10. The method of claim 7 further comprising recording the number of instances of the text that is found on each of the one or more pages.

11. The method of claim 1 wherein the input is a location.

12. The method of claim 11 wherein the search parameter generated are one or more road names based on the location.

13. The method of claim 12 wherein the search parameter is generated from the set of directions to reach the location, the search parameter comprising the one or more road names.

14. The method of claim 13 wherein upon having found the text of at least one of the one or more road names, the action performed is providing an audio or a visual indication to move in a certain direction based on the set of direction.

15. The method of claim 11 wherein one or more road names are identified which are near the location, the search parameter comprising the one or more road names.

16. The method of claim 15 wherein upon having found the text of at least one of the one or more of the road names, the action performed is providing a second location comprising the road name that has been found.

17. An electronic device comprising:
a display;
a camera configured to capture at least one image; and
a processor connected to the display and the camera, and configured to receive an input, generate a search parameter from the input, the search parameter comprising the text, apply optical character recognition to the at least one image to generate computer readable text, apply the search parameter to search for the text in the computer readable text, and if the text is found, perform an action.

18. The method of claim 17 wherein the input is text.

19. The method of claim 18 wherein the action performed is highlighting the text that is found on the display.

20. A system comprising:
a display;
a camera configured to capture at least one image; and
a processor connected to the display and the camera, and configured to receive an input, generate a search parameter from the input, the search parameter comprising the text, apply optical character recognition to the at least one image to generate computer readable text, apply the search parameter to search for the text in the computer readable text, and if the text is found, perform an action.
